(19) United States
(12) Patent Application Publication
(10) Pub. No.: US 2026/0323325 A1
(43) Pub. Date: Oct. 15, 2026

(54) METHOD AND APPARATUS FOR NETWORK PERFORMANCE MANAGEMENT

(71) Applicant: Samsung Electronics Co., Ltd., Gyeonggi-do (KR)

(72) Inventors: Ashutosh KAUSHIK, Bangalore (IN); Deepanshu GAUTAM, Bangalore (IN); Erik GUTTMAN, Staines Middlesex (GB)

(21) Appl. No.: 19/101,140

(22) PCT Filed: Aug. 7, 2023
(86) PCT No.: PCT/KR2023/011568

§ 371 Date: Feb. 4, 2025

(30) Foreign Application Priority Data
Aug. 6, 2022 (IN) 202241044993
Jul. 20, 2023 (IN) 202241044993

(51) Int. Cl. H04W 24/08; H04L 43/0805; H04L 43/16

(52) U.S. Cl. CPC H04W 24/08; H04L 43/0805; H04L 43/16

(57) ABSTRACT

The disclosure relates to a 5G or 6G communication system for supporting a higher data transmission rate. The present disclosure provides a method and system for network performance management. A method performed by a mobile network operator (MNO) in a wireless communication system for network performance measurement, the method includes receiving, from a distribution system operator (DSO), a request for measuring performance metrics of a cell of a network, generating an information object class (IOC) response for the request, and transmitting, to the DSO, the (IOC) response.

### TECHNICAL FIELD

The present disclosure relates, in general, to wireless telecommunication network. Particularly, the present disclosure relates to a method and apparatus for network performance measurement by a mobile network operator (MNO) system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

The Distribution System Operator (DSO) is a natural or legal person who is responsible for operating, ensuring the maintenance of and, if necessary, developing the distribution system in a given area and, where applicable, its interconnections with other systems, and for ensuring the long-term ability of the system to meet reasonable demands for the distribution of electricity.

The delivery of electrical energy must occur with extreme levels of availability. It is crucial in this domain, for regulatory, business and public health and safety requirements. To achieve this reliable availability, a range of ‘smart energy services are employed by the energy system. These services, largely standardized by IEEE and IEC, require communication. As greater degrees of efficiency, resiliency, responsiveness and other capabilities are sought in the generation and delivery of electricity, more and more communications services are required by the electrical energy sector. To the extent that the 3GPP communication system can provide services that meet the needs of the electrical energy sector, telecommunications will be an increasingly important part of the technical ecosystem by which electricity is delivered.

The energy utility service provider needs information regarding “outages” and performance degradation of the communication system, as it may be possible for the energy utility service provider to establish and use an alternative means of communication reactively or even proactively. There is currently no mechanism to convey network or services status from the MNO to the DSO in a standardized way. While the DSO can access information from their Customer Premises Equipment (CPEs), no information comes from the MNO system. The actual availability of mobile network services is not exposed to energy utility service providers (customers). This makes it difficult for energy utilities to perform risk assessment and network planning for communication services to carry their smart energy services. In case network or service failure is happening or has happened in an area, the DSO can just infer this situation through a qualified guest. If the DSO is forced to use a standard MNO service and network, with no specific “availability” target, and no mechanism to know that the network or service is failing or has failed in an area, the DSO will not rely on MNO network and will develop alternative telecommunications infrastructure that will eventually make MNOs' services unnecessary.

The existing standard mechanisms do not allow a third party (e.g., DSO) to request any sort of reports from the 3GPP management system in a standardized way. Thus, there exists a need of techniques that may inform the DSO about the network performance measurement to ensure the long-term ability and to meet reasonable demands for the distribution of the electricity.

The information disclosed in this background of the disclosure section is only for enhancement of understanding of the general background of the invention and should not be taken as an acknowledgement or any form of suggestion that this information forms the prior art already known to a person skilled in the art.

### DISCLOSURE OF INVENTION

### Technical Problem

The present invention has been made to address at least the above problems and/or disadvantages and to provide at least the advantages described below. Accordingly, an aspect of the present invention provides a method and an apparatus for network performance management.

### Solution to Problem

One or more shortcomings of the conventional systems are overcome by system and method as claimed and additional advantages are provided through the provision of system and method as claimed in the present disclosure. Additional features and advantages are realized through the techniques of the present disclosure. Other embodiments and aspects of the disclosure are described in detail herein and are considered a part of the claimed disclosure.

In one embodiment, the present disclosure discloses a method for network performance measurement. The method may comprise receiving a request for monitoring performance metrics of an object (e.g. cell) of a communication network from a distribution system operator (DSO). The request comprises a threshold value for each of the performance metrics, identifier and/or location information of the object to be monitored (e.g. cell), and a time period of monitoring. Upon receiving the request, the method comprises sending a request to a performance assurance entity for calculating the performance metrics of the cell within the time period and based on the identifier and/or location information of the monitored object (e.g. cell) performance metrics. Further, the method comprises receiving the performance metrics being calculated from the performance assurance entity. The performance metrics comprise one or more cell performance measurements and one or more Key Performance Identifiers (KPIs). Thereafter, the method comprises comparing the calculated performance metrics with the respective threshold values to determine whether at least one of the calculated performance metrics exceeds the respective threshold value. Finally, method comprises transmitting notification for threshold crossing for the calculated performance metrics to the DSO when at least one of the calculated performance metrics exceeds the respective threshold value and transmitting the calculated performance metrics to the DSO.

In another embodiment, the present disclosure discloses a method of network performance measurement being performed by a mobile network operator (MNO) system (101). The method may comprise receiving a request for monitoring performance metrics of a an object (e.g. cell) of a communication network from a distribution system operator (DSO). The request comprises a threshold value for each of the performance metrics, identifier and/or location information of the object to be monitored (e.g. cell), and a time period of monitoring. The method comprises sending a request to a performance assurance entity for calculating the performance metrics of the cell within the time period and based on the identifier and/or location information of the monitored object (e.g. cell) and receiving the performance metrics being calculated from the performance insurance entity. The performance metrics comprises one or more cell performance measurements and one or more Key Performance Identifiers (KPIs). The method comprises receiving a request to send notification to the DSO when at least one of the performance metrics exceeds the respective threshold value, transmitting the notification for threshold crossing for the calculated performance metrics to the DSO when at least one of the performance metrics exceeds the respective threshold value, and transmitting the performance metrics to the DSO.

In another embodiment, the present disclosure discloses a mobile network operator (MNO) system for network performance measurement. The MNO system may comprise a transceiver, a processor communicatively coupled with the transceiver; and a memory communicatively coupled to the processor and the transceiver. The processor is configured to receive a request for monitoring performance metrics of an object (e.g. cell) of a communication network from a distribution system operator (DSO). The request comprises a threshold value for each of the performance metrics, identifier and/or location information of the object to be monitored (e.g. cell), and time period of monitoring, the processor further sends, via the transceiver, a request to a performance assurance entity for calculating the performance metrics of the cell within the time period and based on the identifier and/or location information of the monitored object (e.g. cell), and receive, via the transceiver, the performance metrics being calculated from the performance insurance entity. The performance metrics comprise one or more cell performance measurements and one or more Key Performance Identifiers (KPIs). Thereafter, the processor causes the apparatus to compare the calculated performance metrics with the respective threshold values to determine whether at least one of the calculated performance metrics exceeds the respective threshold value. Finally, the processor causes the apparatus to transmit notification for threshold crossing for calculated performance metrics to the DSO when at least one of the calculated performance metrics exceeds the respective threshold value and transmit the calculated performance metrics to the DSO.

In another embodiment, the present disclosure discloses a mobile network operator (MNO) system (101) for network performance measurement. The MNO system (101) may comprise a transceiver (107), a processor (105) communicatively coupled with the transceiver, and a memory (109) communicatively coupled to the processor and the transceiver. The processor is configured to: receive a request for monitoring performance metrics of an object (e.g. cell) of a communication network from a distribution system operator (DSO), wherein the request comprises a threshold value for each of the performance metrics, identifier and/or location information of the object to be monitored (e.g. cell), and a time period of monitoring; send a request to a performance assurance entity for calculating the performance metrics of the cell within the time period and based on the identifier and/or location information of the monitored object (e.g. cell); receive the performance metrics being calculated from the performance assurance entity, wherein the performance metrics comprises one or more cell performance measurements and one or more Key Performance Identifiers (KPIs); receive a request to send notification to the DSO when at least one of the performance metrics exceeds respective threshold value; transmit the notification for threshold crossing for the calculated performance metrics to the DSO when the at least one of the performance metrics exceeds the respective threshold value; and transmit the performance metrics to the DSO.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for a method and an apparatus for network performance management.

### BRIEF DESCRIPTION OF DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment for network performance measurement, in accordance with some embodiments of the present disclosure;

FIG. 2 shows a detailed block diagram illustrating MNO system for network performance measurement, in accordance with some embodiments of the present disclosure.

FIG. 3A illustrates the signal flow diagram of transmitting the calculated performance metrics to DSO based on an implicit subscription in accordance with some embodiments of the present disclosure;

FIG. 3B illustrates the signal flow diagram of transmitting the calculated performance metrics to DSO based on an explicit subscription, in accordance with some embodiments of the present disclosure;

FIG. 3C illustrates the signal flow diagram of network performance measurement based on dedicated service configuration, in accordance with some embodiments of the present disclosure.

FIG. 4 illustrates a method for network performance measurement based on NRM configuration, in accordance with some embodiments of the present disclosure.

FIG. 5 illustrates a method for network performance measurement based on dedicated service configuration, in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

The figures depict embodiments of the disclosure for purposes of illustration only. One skilled in the art will readily recognize from the following description that alternative embodiments of the structures and methods illustrated herein may be employed without departing from the principles of the disclosure described herein.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following specification particularly describes and ascertains the nature of this invention and the manner in which it is to be performed:

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Disclosed herein are a method and an apparatus for network performance measurement. The network performance may be defined by the overall quality of service provided by a network. Further, network performance monitoring (NPM) is the process of measuring and monitoring the quality of service of the network. The NPM helps network administrators to gather network data, measure performance variables and identify potential issues or risks. To measure the network performance, a Distributed System Operator (DSO) may monitor the performance metrics of the network and identify potential risks. In other words, the Distribution System Operators (DSO) are the entities responsible for distributing and managing energy from the generation sources to one or more users. In an embodiment, the DSO may use smart meters that allow bi-directional reading of the energy flow and real-time communication. As a result, it becomes possible to detect interruptions and restore the supply automatically, and it also facilitates the monitoring of user's daily consumption through digital consultation platforms.

In some embodiments, to measure the network performance, the DSO may initially send a request for measuring performance metrics of a cell of a communication network to a system that may measure the performance metrics of the network. For instance, the system measuring the network performance may be a Mobile network operator (MNO) system. The request may include a threshold value for each of the performance metrics and at least one of an identifier and location of the cell to be measured. Upon receiving the request, the performance metrics of the cell may be calculated based on the identifier and/or location of the cell for a time period. The performance metrics may comprise one or more cell performance measurements and one or more Key Performance Identifiers (KPIs). Further, the calculated performance metrics may be compared with the respective threshold values to determine whether any of the calculated performance metrics exceed the respective threshold values. Upon comparing the calculated performance metrics with the respective threshold values, a notification may be transmitted when any of the calculated performance metrics exceed the respective threshold value and about the calculated performance metrics to the DSO.

The present disclosure discloses network performance measurement to identify cell or network availability degradation or failure, cell outage indicated by disclosed measurements and KPIs may be correlated with network performance events. The network performance may be compared with historic information indicating failures. This may help the DSO to take timely reactive or even proactive actions to maintain its smart energy services. Further, the one or more measurements and KPIs information may enhance the MNO service and network visibility for specific user groups (e.g., DSO) that may benefit from this, while making sure that some of them do not develop alternative solutions they can fully control. The present disclosure also provides the ability for the consumer or the user to configure thresholds with the performance measurement defined as part of this invention for a particular location of the target node. As a result, when the current measurement exceeds the configured threshold, then the present disclosure may identify cell or network availability degradation or failure.

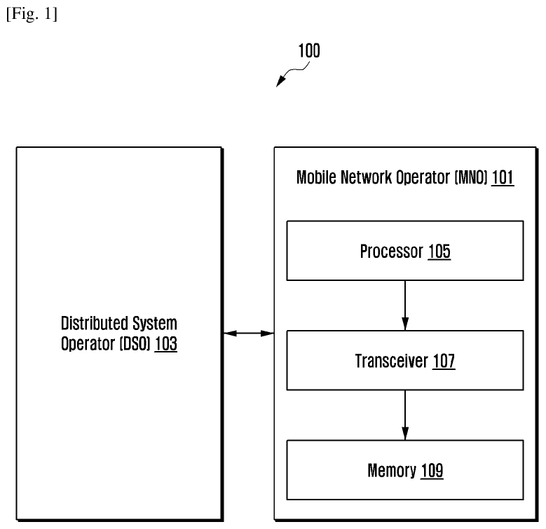

FIG. 1 shows an exemplary environment for network performance measurement in accordance with some embodiments of the present disclosure. In some embodiments, the environment discloses a Mobile network operator (MNO) system 101 and a Distributed system operator (DSO) 103. The Distribution System Operator (DSO) 103 may be a natural or legal person who is responsible for operating, ensuring the maintenance of energy. Further, the DSO 103 may provide interconnections within the given area along with other systems for ensuring the long-term ability of the system to meet reasonable demands for the distribution of electricity. In other words, the DSO 103 may monitor the performance metrics of the network and identify potential risks.

In some embodiments, the MNO system 101 may be a smartphone, a tablet phone, a desktop computer, a laptop, and the like. The MNO system 101 may be responsible for measuring network performance based on the request from the DSO 103. The Mobile network operator (MNO) system 101 may comprise a processor 105, a transceiver 107 and a memory 109, but not limited thereto.

In an embodiment, the performance of the cell may be measured based on two different configurations i.e. i) Network Resource Model (NRM) based configuration and ii) dedicated service based configuration. The following paragraphs explain both configurations in more detail.

### Network Resource Model (NRM) Based Configuration:

In some embodiments, the processor may receive the request as per generic provisioning MnS for monitoring performance metrics of a cell of a communication network from the DSO 103. The request may comprise a threshold value for each of the performance metrics, an identifier and/or location information of the cell, and a time period of monitoring, but not limited thereto. In an alternative embodiment, the request may also include a subscription type such as explicit subscription and implicit subscription. Based on the request received, the performance metrics of the cell may be calculated within a specified time period by the processor based on the identifier and/or location information of the cell. The identifier or location information of the cell may comprise latitude, longitude information, tracking area code (TAC), and cell Id information. In an embodiment, the performance metrics may be one or more cell performance measurements and one or more Key Performance Identifiers (KPIs). The one or more cell performance measurements may be selected from a group of: a total cell outage duration, an average cell outage duration, and a total cell in-service duration, but not limited thereto. Further, the one or more cell KPIs may be selected from a group of: an average cell availability, and an average network availability, but not limited thereto. The calculated performance metrics are compared with the respective threshold values to determine whether any one of the calculated performance metrics exceeds the respective threshold value. Finally, the notification for threshold crossing for calculated performance metrics is sent to the DSO 103 when at least one of the calculated performance metrics exceeds the respective threshold value and also the calculated performance metrics are transmitted to the DSO 103 based on the subscription type of the DSO 103.

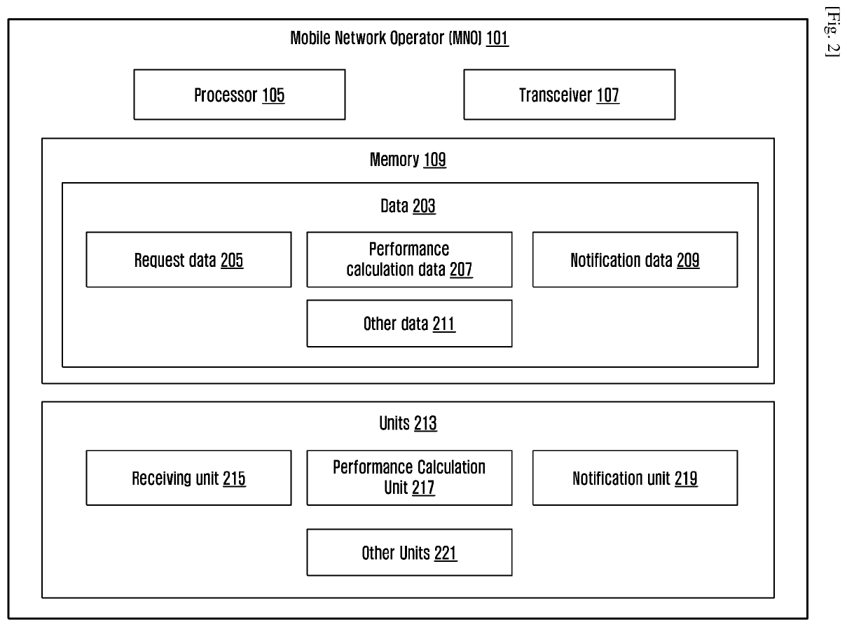

FIG. 2 shows a detailed block diagram illustrating MNO system 101 for network performance measurement, in accordance with some embodiments of the present disclosure.

In an implementation, the MNO system 101 may comprise a processor 105, a transceiver 107 and a memory 109. The transceiver 107 may be configured to communicate with one or more sources and/or external equipment. In an embodiment, the memory 109 may be communicatively coupled to the processor 105. The processor 105 may be configured to perform one or more functions of the MNO system 101.

In some implementations, the MNO system 101 may include data 203 and units 213 for performing various operations in accordance with the embodiments of the present disclosure. In an embodiment, the data 203 may be stored within the memory 109 and may include, but not limited to, request data 205, performance calculation data 207, notification data 209 and other data 211.

In some embodiments, the data 203 may be stored within the memory 109 in the form of various data structures. Additionally, the data 201 may be organized using data models, such as relational or hierarchical data models. The other data may store temporary data and temporary files, generated by the units 213 while performing various functions of the MNO system 101.

In some embodiments, the request data 205 may include data or values relating to a request as per generic provisioning MnS for monitoring performance metrics of a cell of a communication network from a distribution system operator (DSO) 103. The request may comprise a threshold value for each of the performance metrics, an identifier and/or location information of the cell, a time period for monitoring the performance metrics of the cell, but not limited thereto. In an alternative embodiment, the request for monitoring the performance metrics of a cell of a communication network may be of any type of subscription for receiving the performance metrics. For instance, the type of subscription may be implicit subscription or explicit subscription based on which the calculated performance attributed may be sent to DSO 103. In an embodiment, the DSO 103 may send the request for monitoring the performance metrics of the cell to a threshold monitoring entity which may be a part of the MNO system 101.

In some embodiments, the performance calculation data 207 may include data of the calculated performance metrics of the cell for a specified predefined time period as indicated in the request for monitoring. In other words, when the request is received from DSO 103 for network performance measurement, then the performance metrics of the cell may be calculated. The performance metrics may comprise one or more cell performance measurements and one or more Key Performance Identifiers (KPIs), but not limited thereto. The one or more cell performance measurements may be selected from a group of: Total cell outage duration, Average cell outage duration and Total cell In-Service duration, but not limited thereto. The performance metrics may be calculated for each of the cell present in the communication network and the calculated performance metrics may be stored in association with the identifier and/or location information (latitude, longitude information, tracking area code (TAC), and cell Id) corresponding to the cell. For instance, there may be 50 cells in the communication network, the performance metrics of each cell are calculated, and the values may be stored across each cell identifier and/or location information to identify performance metrics which exceed the respective threshold value. Further, the one or more cell KPIs may be selected from a group of: an average cell availability, and an average network availability. Upon calculating the performance metrics of the cell for the specified time period based on the identifier and/or location of the cell, the calculated performance metrics may be compared with the respective threshold values to determine whether any of the calculated performance metrics exceeds the respective threshold value. In an embodiment, upon receiving the request for monitoring the performance metrics from the DSO, the threshold monitoring entity may send a request to a performance assurance entity for calculating the performance metrics of the cell within the time period specified in the request for monitoring based on the identifier and/or location information of the cell. In response, the performance assurance entity may calculate the performance metrics of the cell and send the calculated attributes to the threshold monitoring entity. The threshold monitoring entity may receive the performance attribute being calculated from the performance assurance entity. Thereafter, the calculated performance metrics may be compared with the respective threshold values to determine whether at least one of the calculated performance metrics exceeds the respective threshold value.

In some embodiments, the notification data 209 relates data or message related to calculated performance metrics that are exceeding the respective threshold value. When the calculated performance metrics are compared with the respective threshold values and any of the calculated performance metrics exceeds the respective threshold value, then a notification may be transmitted for threshold crossing for calculated performance metrics to the DSO 103. In some embodiments, when the calculated performance metrics exceed the respective threshold value, then the calculated performance metrics may be transmitted to the DSO 103. The calculated performance metrics may be transmitted to DSO 103 based on at least one of an explicit subscription or an implicit subscription. In an embodiment, the explicit subscription comprises receiving a subscription control message from the DSO 103, and the subscription control message comprises an address of the DSO 103 to receive the notification and performance metrics. In another embodiment, the notification may be transmitted to DSO 103 when any of the calculated performance metrics exceeds the threshold which is based on at least one of the explicit subscription or the implicit subscription.

In an embodiment, data 203 may be processed by one or more units 213 of MNO system 101. As used herein, the term unit refers to an Application Specific Integrated Circuit (ASIC), an electronic circuit, a processor (shared, dedicated, or group) and memory 109 that execute one or more software or firmware programs, a combinational logic circuit, and/or other suitable components that provide the described functionality. In an embodiment, the other units 221 may be used to perform various miscellaneous functionalities of the MNO system 101. It will be appreciated that such units 213 may be represented as a single unit or a combination of different units.

In one implementation, the one or more units 213 may be stored as instructions executable by the processor 105. In another implementation, each of the one or more units 213 may be separate hardware units, communicatively coupled to the processor 105 for performing one or more functions of MNO system 101. The one or more units 213 may include, without limiting to, receiving unit 215, performance calculation unit 217, notification unit 219 and other units 221.

In an embodiment, the receiving unit 215 may receive the request from DSO 103 for monitoring performance metrics of a cell of a communication network. The request may comprise a threshold value for each of the performance metrics, an identifier and/or location information of the cell, a time period of monitoring, but not limited thereto. In an alternative embodiment, receiving unit 215 may receive the request that may comprise measuring performance metrics of the cell of the communication network and the type of subscription. For instance, the type of subscription may be implicit subscription or explicit subscription based on which the calculated performance attributed may be transmitted to DSO 103.

In some embodiments, the performance calculation unit 217 may calculate performance metrics of the cell within the specified time period of monitoring based on the identifier and/or location information of the cell. In other words, when the request is received from DSO 103 for network performance measurement, then the performance metrics of the cell may be calculated. The performance metrics may comprise one or more cell performance measurements and one or more Key Performance Identifiers (KPIs). The one or more cell performance measurements may be selected from a group of: a total cell outage duration, an average cell outage duration, and a total cell in-service duration, but not limited thereto. The total cell outage duration may indicate a total time duration when the cell in the communication network is out of service. The performance calculation unit 217 may calculate total cell outage duration by determining one or more, time intervals between time stamps Tout and Tin, Tout is the time stamp when Service Status is reported as “Out-Of-Service” by gNB-DU to gNB-CU for a cell and Tin is the time stamp when the Service Status is reported as “In-Service” for the same cell by gNB-DU to gNB-CU in the GNB DU CONFIGURATION UPDATE messages. Further, performance calculation unit 217 may sum up the one or more time intervals of the cell which are determined within the specified time period to calculate the total cell outage duration. If there is no In-Service status reported within the specified time period for a cell, then for such cell Tin should be taken as the point in time when the measurement is being performed. The measurement is split into sub-counters per NCGI (NR Cell Global Identity). The NCGI is an identifier for the cell. Each measurement is an integer value representing the number of seconds or minutes or hours for which the cell was Out-Of-Service. The number of measurements is equal to the number of NCGIs (cells).

The average cell outage duration may indicate an average time duration of an outage when the cell in the communication network is out of service. The performance calculation unit 217 calculates the average cell outage duration by dividing the total cell outage duration with a number of occurrences of outage for the cell within the specified time period. The measurement is split into sub-counters per NCGI. Each measurement is an integer value representing the average number of seconds or minutes or hours for which the cell was Out-Of-Service per outage occurrence. The number of measurements is equal to the number of NCGIs (cells).

Further, the total cell In-Service duration may indicate a total time duration when the cell in the communication network is in-service. The performance calculation unit 217 calculates the total cell in-service duration by determining one or more, time intervals between time stamps Tin and Tout, where Tin is the time stamp when the Service Status is reported as “In-Service” for a cell by gNB-DU to gNB-CU and Tout is the time stamp when Service Status is reported as “Out-Of-Service” by gNB-DU to gNB-CU for the same cell in the GNB DU CONFIGURATION UPDATE messages. Further, the performance calculation unit 217 may sum up the one or more-time intervals of the cell which are determined within the specified time period to calculate the total cell In-Service duration. If there is no Out-Of-Service status reported within specified time period, then for such cell Tout should be taken as the point in time when the measurement is being performed. The measurement is split into sub-counters per NCGI. Each measurement is an integer value representing the number of minutes for which the cell was in-Service. The number of measurements is equal to the number of NCGIs (cells).

The one or more cell KPIs may be selected from a group of: average cell availability and an average network availability, but not limited thereto. The average cell availability may be calculated by summing up all measurements for the total cell In-Service duration and then dividing the result by total number of active cells (NR CGIs) present in Cells Status List in GNB-DU CONFIGURATION UPDATE message of all the gNB-DUs in a gNB-CU as explained in TS 38.473 clause 9.2.1.7. It is a time duration value obtained in seconds or minutes or hours. Further, the average network availability is calculated based on the average cell availability and a number of base stations (gNB-CUs) present in the communication network. It is obtained by summing all measurements of average cell availability and then dividing the result by the total number of gNB-CUs present in the network. It is a time duration value obtained in seconds or minutes or hours.

Further, based on the calculated performance metrics such as one or more cell performance measurement and one or more KPIs, the performance calculation unit 217 may compare the calculated performance metrics with the respective threshold values to determine whether at least one of the calculated performance metrics exceeds the respective threshold value.

For instance, the MNO system 101 may configure threshold values and performance metrics for network performance measurement using input parameters to identify the network performance of the communication network. The input parameters may comprise thresholdinfolist, and monitorGranularityPeriod. The thresholdinfolist is datatype for providing details of the threshold setting related parameters and may comprises a list of thresholdinfos with the following attributes: performanceMetrics, threshodDirection, thresholdValue, and targetThresholdlocation. Further, the performanceMetrics represents at least one of the cell performance measurements and KPI under consideration which is to be monitored for exceeding threshold value. To check if the calculated performance metrics exceed the respective thresholdValue parameter may be used. The thresholdValuewill have different values depending on the performance metrics. The input parameter thresholdDirection. represents the direction in which the measured performance metrics crosses the configured thresholdValue and triggers a notification which have values in “UP” and “DOWN” format. The parameter thresholdDirection may have a value as: DOWN, if performanceMetrics value is CellAvailAvg KPI; DOWN, if performanceMetrics value is NwAvailAvg KPI; UP, if performanceMetrics value is SO.CellOOSTimeTotal.NCGI measurement; UP, if performanceMetrics value is SO.CellOOSTimeAverage.NCGI measurement; and DOWN, if performanceMetrics value is SO.CellInServiceTotal.NCGI measurement. The parameter targetThresholdlocation will may comprise the location (Lat/long, TAC, cellid). Further, monitorGranularityPeriod represents the period for which a performance metric is monitored for threshold crossing detection. The period is defined in seconds or minutes or hours.

The notification unit 219 transmits the notification for threshold crossing for calculated performance metrics to DSO 103 when at least one of the calculated performance metrics exceeds the respective threshold value. Further, the notification unit 219 may also transmit the calculated performance metrics to the DSO 103. In one embodiment, the notification unit 219 transmits the notification for threshold crossing for calculated performance metrics based on at least one of an explicit subscription or an implicit subscription. If the performanceMetrics value crosses the configured thresholdValue, the threshold monitoring entity may send notifyThresholdCrossing notification to the DSO. In an embodiment, in an event of the explicit subscription, in addition to the above parameter, the may DSO send createMOI for NtfSubscriptionControl IOC. The attribute notificationRecipientAddress may comprise the address of the notification recipient i.e. DSO.

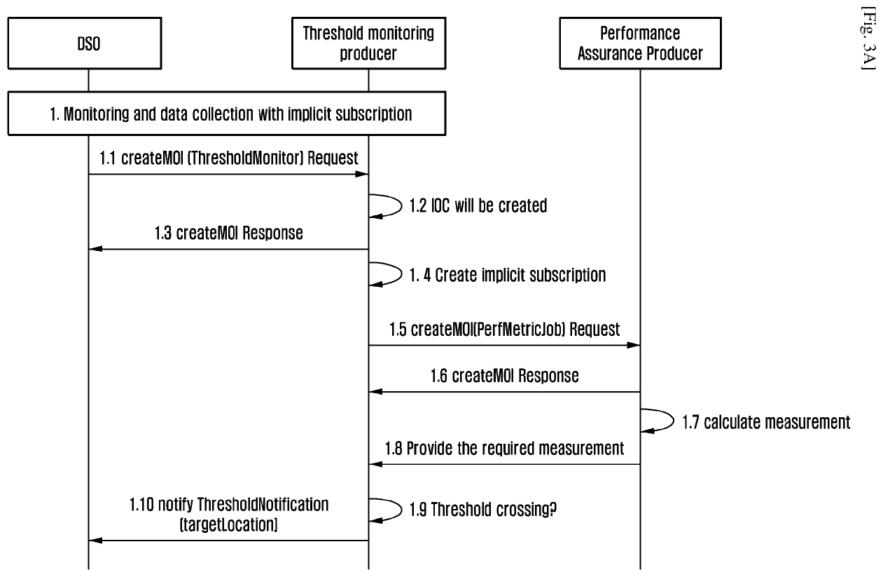

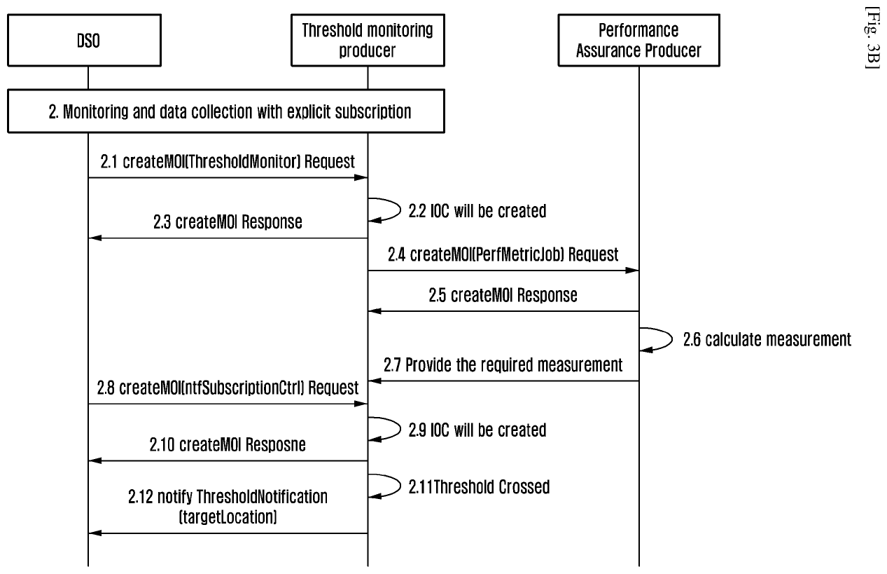

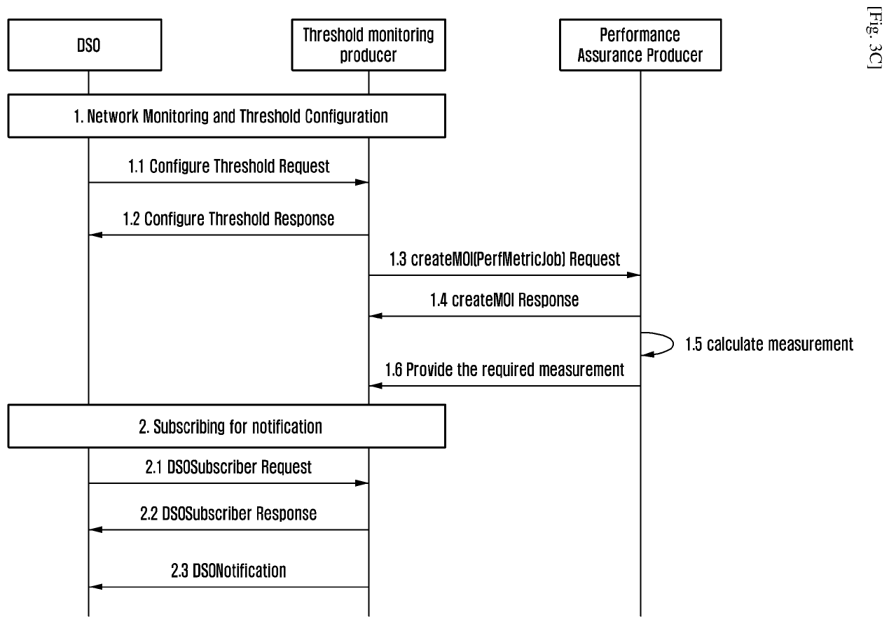

For ease of understanding, the step of transmitting the calculated performance metrics based on at least one of an explicit subscription or an implicit subscription may be explained with a signal flow diagram. FIG. 3A illustrates the implicit subscription. Initially, the DSO 103 may share the request for measuring performance metrics of a cell of a communication network to a threshold monitoring producer [step 1.1 of FIG. 3A]. Upon receiving the request from DSO 103, an Information Object Class (IOC) may be created for each and every request from DSO 103 [step 1.2 of 3A]. Thereafter, the create IOC response is shared to DSO 103 [step 1.3 of 3A]. In other words, a channel may be created for each of the request from DSO 103 and the measurements are shared back to DSO 103 using the created channel. Further, threshold monitoring producer may send a create MOI request to performance assurance producer and the performance assurance producer may respond. The performance assurance may calculate the performance metrics of the cell within the specified time period based on the identifier and/or location of the cell [as shown in step 1.7 of 3A]. The performance metrics comprise one or more cell performance measurements and KPIs. The calculated performance metrics of the cell may be sent to threshold monitoring producer [as shown in step 1.8 of 3A]. Further, threshold monitoring producer of the MNO 101 compares the calculated performance metrics with the respective threshold values to determine whether at least one of the calculated performance metrics exceeds the respective threshold value. When the calculated performance metrics exceeded the respective threshold value, then the threshold monitoring producer may transmit the notification for threshold crossing for calculated performance metrics to the DSO 103 when at least one of the calculated performance metrics exceeds the respective threshold value. In another embodiment, the threshold monitoring producer may transmit the calculated performance metrics to the DSO 103 [step 1.9 of 3A].

Referring to FIG. 3B which illustrates the flow of transmitting the calculated performance metrics to DSO based on an explicit subscription. Initially, the DSO 103 may share the request for measuring performance metrics of a cell of a communication network to threshold monitoring producer [step 2.1 of FIG. 3B]. Upon receiving the request from DSO 103, an Information Object Class (IOC) may be created for each and every request from DSO 103 [step 2.2 of 3B]. Thereafter, the created IOC response is shared to the DSO 103 [step 2.3 of 3B]. Further, threshold monitoring producer may send a create MOI to a performance assurance producer and the performance assurance producer may respond [step 2.4 and 2.5 of FIG. 3B]. The performance assurance producer may calculate the performance metrics of the cell within a specified time period based on the identifier and/or location of the cell [step 2.6 of FIG. 3B]. The performance metrics comprise one or more cell performance measurements and KPIs. The calculated the performance metrics of the cell are sent to threshold monitoring producer [as shown in step 2.7 of 3B]. Once the performance metrics are calculated, the DSO may request the threshold monitoring producer to share the calculated performance metrics through a created channel MOI that is created through which the MNO may respond [step 2.10 of FIG. 3B]. When the request is received from DSO, the threshold monitoring producer may compare the calculated performance metrics with the respective threshold values to determine whether at least one of the calculated performance metrics exceeds the respective threshold value [step 2.11 of FIG. 3B]. When the calculated performance metrics exceeded the respective threshold value, then the threshold monitoring producer may transmit the notification for threshold crossing for calculated performance metrics to the DSO 103 when at least one of the calculated performance metrics exceeds the respective threshold value. In another embodiment, the threshold monitoring producer transmit the calculated performance metrics to the DSO 103 [step 2.12 of FIG. 3B].

### Dedicated Service Based Configuration:

In accordance with an embodiment, in the dedicated configuration, initially, the network monitoring and threshold configuration is performed and thereafter, notification subscription is configured. In this approach/configuration, initially the MNO 101 may receive a request as per dedicated MNO reporting MnS for monitoring performance metrics of a cell of a communication network from a distribution system operator (DSO) 103. The request comprises a threshold information (threshold level and threshold crossing direction) for each of the performance metrics, an identifier and/or location information of the cell, and a time period of monitoring, but not limited thereto. Upon receiving the request, the MNO 101 may send a request to a performance assurance entity for calculating the performance metrics of the cell within the time period and based on the identifier and/or location information of the cell. The performance assurance entity may calculate the performance metric measurements as requested and send to the MNO 101. Thereafter, the MNO 101 may receive the performance metric measurements being calculated from the performance assurance entity. The performance metrics may comprises one or more cell performance measurements and one or more Key Performance Identifiers (KPIs). Thereafter, the MNO 101 may receive a request for subscription operation configuration to subscribe for notification from MNO when threshold level is crossed for a performance metric under monitoring and further receive a request for notification operation configuration to send notification to the DSO 103 when at least one of the performance metric exceeds the respective threshold value. The MNO 101 may transmit the notification for threshold crossing for the calculated performance metrics to the DSO when the at least one of the performance metrics exceeds the respective threshold value, and thereafter may transmit the performance metrics to the DSO 103.

In an embodiment, the MNO system 101 may configure threshold information and performance metrics measurements for network performance measurement using input parameters to identify the network performance of the communication network. The input parameters may comprise thresholdinfo, and perfirmaceMetric, thresholdLevel, theresholdCrossingdirection, monitorPeriod, and thresholdMonitorLocation. These parameters are defined in the below table.

| Parameter Name | Qualifier | Description | Properties |
|---|---|---|---|
| Thresholdinfo | M | This is data type providing | type: complex type |
| | | details of the threshold | multiplicity: * |
| | | setting related parameters. | isUnique: True |
| | | | defaultValue: |
| | | | None |
| | | | isNullable: False |
| >PerformanceMetric | M | This represents the | type: String |
| | | measurement and/or KPI | multiplicity: 1 |
| | | under consideration which | isUnique: True |
| | | is to be monitored for | defaultValue: |
| | | exceeding threshold value | None |
| | | | isNullable: False |
| >thresholdLevel | M | To check if the calculated | type: Union |
| | | performance metrics | multiplicity: 1 |
| | | exceed the respective | defaultValue: |
| | | threshold value. It will | None |
| | | have different values | isNullable: False |
| | | depending on the | |
| | | performance metrics. Its | |
| | | value is in seconds or | |
| | | minutes or hours. | |
| >thresholdCrossingdirection | M | This represents the | type: ENUM |
| | | direction in which the | multiplicity: 1 |
| | | measured performance | defaultValue: |
| | | metrics crosses the | None |
| | | configured thresholdLevel | isNullable: False |
| | | and triggers a notification. | |
| | | It can have values: “UP” | |
| | | and “DOWN”. | |
| >monitoringPeriod | M | This represents the | type: Ineger |
| | | granularity of the period | multiplicity: 1 |
| | | for which a performance | isUnique: True |
| | | metric is monitored for | defaultValue: |
| | | threshold crossing | None |
| | | detection. Its value is in | isNullable: False |
| | | minutes. | |
| >thresholdMonitorLocation | M | This represents the target | type: Complex |
| | | location to scope the | type |
| | | managed object where | multiplicity: 1 |
| | | measurements and their | isUnique: True |
| | | threshold crossing is | defaultValue: |
| | | monitored. This can have | None |
| | | possible values as | isNullable: False |
| | | Lat/Long, Geographical | |
| | | Area, TAC, Cell Id. | |

Based on the input parameters, the status of configuring threshold request operation may be indicated by an output parameter. The below table provides further details for the output parameter.

| Parameter Name | Qualifier | Description | Properties |
|---|---|---|---|
| ConfigThreshStatus | M | This gives the status of | type: ENUM |
| | | the Configuring | multiplicity: 1 |
| | | Threshold Request | defaultValue: None |
| | | operation. | allowedValues: |
| | | | SUCCESS, |
| | | | FAILURE |
| | | | isNullable: False |

Further, the calculated performance metric measurements may be transmitted to the DSO 103 upon receiving a subscription request from the DSO 103. The DSO 103 may send subscription request for notification from MNO system 101. In an embodiment, the DSO may also send the parameters that need to be configured for notification subscription. The input parameters to configure the notification subscription may be as listed below. The input parameters may comprise RequiredNotification and RequestedExpiryperiod. The RequiredNotification gives the notification type for which subscription is made by DSO. For instance, the value is NtfyThresholdLevelCrossing. Further, RequestedExpiryperiod represents the requested time period for which subscription is valid. Based on the input parameters, the output parameter SubsId that identifies the subscription request as provided by the MNO system 101, subsStatus that provides the status of the Subscribe request and AllowedExpiryPeriod that represents the time period for which subscription is allowed may be provided by MNO.

### Input Parameters:

| Parameter Name | Qualifier | Description | Properties |
|---|---|---|---|
| RequiredNotification | M | This gives the notification | Type: String |
| | | type for which subscription is | multiplicity: 1 |
| | | made by DSO. For instance, | defaultValue: |
| | | the value is | None |
| | | NtfyThresholdLevelCrossing. | isNullable: |
| | | | False |
| RequestedExpiryperiod | M | This represents the requested | type: integer |
| | | time period for which | multiplicity: 1 |
| | | subscription is valid. Its value | defaultValue: |
| | | is in minutes. | No |
| | | | isNullable: |
| | | | False |

### Output Parameters:

| Parameter Name | Qualifier | Description | Properties |
|---|---|---|---|
| SubsId | M | This is the | Type: String |
| | | identification of | multiplicity: 1 |
| | | the subscription | defaultValue: |
| | | request as provided | None |
| | | by the MNO | isNullable: False |
| | | system 101. | |
| SubsStatus | M | This gives the | Type: ENUM |
| | | status of the | multiplicity: 1 |
| | | Subscribe request. | defaultValue: |
| | | | None |
| | | | allowedValues: |
| | | | Success, Failure |
| | | | isNullable: False |
| AllowedExpiryPeriod | M | This represents the | Type: integer |
| | | time period for | multiplicity: 1 |
| | | which subscription | defaultValue: |
| | | is allowed by | No |
| | | MNO. Its value is | isNullable: False |
| | | in minutes. | |

In some embodiments, the MNO system 101 may notify a subscribed DSO when the performance metric measurements cross the threshold values based on the parameters such as notificationId, requiredNotification, eventTime, monitoredPerfMetricName, monitoredPerfMetricValue, monitoredThreshCrossingdirection, thresholdLevel and montoringPeriod as shown in the below table.

| | Support | | |
|---|---|---|---|
| Parameter Name | Qualifier | Information Type | Comment |
| notificationId | M | — | |
| RequiredNotification | M | ,,NtfyThresholdLevel | |
| | | Crossing“ | |
| eventTime | M | — | Time when the threshold |
| | | | crossing occurred. |
| monitoredPerfMetricName | M | The name of the | Name of the |
| | | Performance Metric as | performance metric that |
| | | defined as part of this | has crossed the |
| | | invention | threshold. |
| monitoredPerfMetricValue | M | performance metric | Value of the |
| | | value | performance metric, |
| | | | which has crossed the |
| | | | threshold, when the |
| | | | threshold crossing was |
| | | | observed |
| monitoredThreshCrossingdirection | M | — | Direction (“UP” or |
| | | | “DOWN”) of the |
| | | | performance metric |
| | | | value, when the |
| | | | threshold crossing was |
| | | | observed |
| thresholdLevel | M | Configured threshold | Threshold level of the |
| | | value | triggered threshold |
| monitoringPeriod | M | Time duration for | Granularity period of the |
| | | monitoring | performance metric |
| | | | monitoring |

This process may be easily understood using FIG. 3C. FIG. 3C illustrates the flow of network performance measurement based on dedicated service configuration. The flow disclosed in FIG. 3C illustrates the signal exchange between the DSO 103, the MNO system 101 and performance assurance producer. Initially DSO may send configure threshold request to MNO system to which the MNO system may respond [as shown in 1.1 and 1.2 of FIG. 3C]. Thereafter, the MNO system 101 may send create MOI request for PerfMetricJob for each request of DSO [as shown in step 1.3 of FIG. 3C]. The performance assurance producer may create PerfMetricJob MOI and respond back to the MNO system 101 [as shown in step 1.4 of FIG. 3C]. Further, the performance assurance producer may calculate the requested performance metrics of the cell within the specified time period based on the identifier and/or location of the cell. The performance metrics comprise one or more cell performance measurements and KPIs and send the calculated measurement to MNO system 101 [as shown in 1.5 of FIG. 3C]. The calculated performance metrics are sent to MNO system 101 [as shown in 1.6 of 3C]. Further, the DSO 103 may send subscription request to MNO to which the MNO may respond [as shown in 2.1 and 2.2 of FIG. 3C]. Further, the MNO system 101 may transmit the notification for threshold crossing for calculated performance metrics to the DSO 103 when at least one of the calculated performance metrics exceeds the respective threshold value. The MNO may also transmit the calculated performance metrics to the DSO 103 [as shown in 2.3 of FIG. 3C].

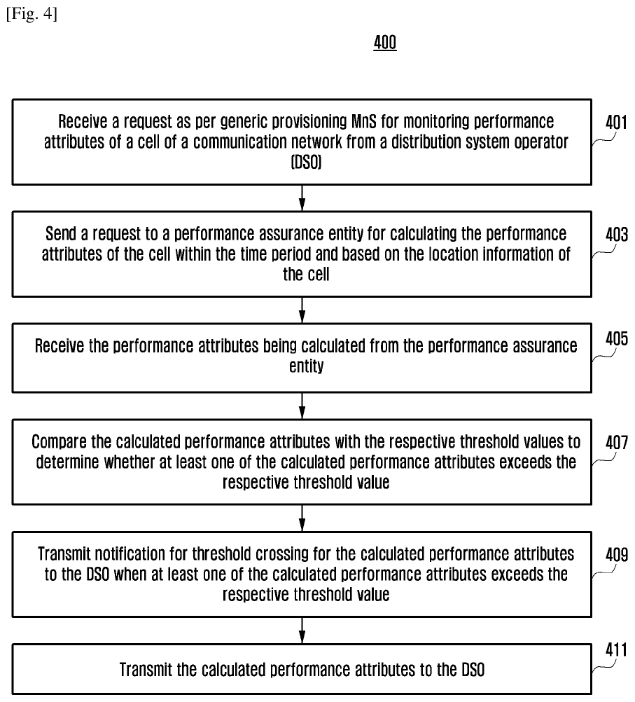

FIG. 4 shows a flowchart illustrating a method for network performance measurement based on NRM based approach, in accordance with some embodiments of the present disclosure.

As illustrated in FIG. 4, the method 400 includes one or more blocks illustrating a method of network performance measurement. The method 400 may be described in the general context of computer executable instructions. Generally, computer executable instructions can include routines, programs, objects, components, data structures, procedures, modules, and functions, which perform functions or implement abstract data types.

The order in which the method 400 is described is not intended to be construed as a limitation, and any number of the described method blocks can be combined in any order to implement the method 400. Additionally, individual blocks may be deleted from the methods without departing from the spirit and scope of the subject matter described herein. Furthermore, the method 400 can be implemented in any suitable hardware, software, firmware, or combination thereof.

At block 401, the method 400 may include receiving, by a threshold monitoring entity of a mobile network operator (MNO) system (101), a request for monitoring performance metrics of a cell of a communication network from a distribution system operator (DSO) 103. The request comprises a threshold value for each of the performance metrics, an identifier and/or location information of the cell, and a time period of monitoring.

At block 403, the method 400 may include sending a request to a performance assurance entity for calculating the performance metrics of the cell within the time period and based on the location information of the cell. At block 405, the method may comprise receiving the performance metrics being calculated from the performance assurance entity. The performance metrics comprise one or more cell performance measurements and one or more cell KPIs. The one or more cell performance measurements are selected from a group of: Total cell outage duration, Average cell outage duration and Total cell In-Service duration. The one or more cell KPIs are selected from a group of: an average cell availability and an average network availability.

The total cell outage duration indicates a total time duration when the cell in the communication network is out of service. The total cell outage duration may be calculated by: determining one or more time intervals between time stamps Tₒᵤₜ and Tᵢₙ, wherein Tout is the time stamp when Service Status is reported as “Out-Of-Service” by gNB-DU to gNB-CU for a cell and Tin is the time stamp when the Service Status is reported as “In-Service” for the same cell by gNB-DU to gNB-CU in the GNB DU CONFIGURATION UPDATE messages; and summing up the one or more time intervals of the cell which are determined within the specified time period to calculate the total cell outage duration. If there is no In-Service status reported within the specified time period for a cell, then for such cell Tin should be taken as the point in time when the measurement is being performed. The measurement is split into sub-counters per NCGI. Each measurement is an integer value representing the number of seconds or minutes or hours for which the cell was Out-Of-Service. The number of measurements is equal to the number of NCGIs (cells). Further, the average cell outage duration indicates an average time duration of an outage when the cell in the communication network is out of service, wherein the average cell outage duration is calculated by dividing the total cell outage duration with a number of occurrences of the outage for the cell within the specified time period. The measurement is split into sub-counters per NCGI. Each measurement is an integer value representing the average number of seconds or minutes or hours for which the cell was Out-Of-Service per outage occurrence. The number of measurements is equal to the number of NCGIs (cells).

Furthermore, the total cell In-Service duration indicates a total time duration when the cell in the communication network is in-service. The total cell in-service duration is calculated by: determining one or more time intervals between time stamps Tᵢₙ and Tₒᵤₜ, where Tin is the time stamp when the Service Status is reported as “In-Service” for a cell by gNB-DU to gNB-CU and Tout is the time stamp when Service Status is reported as “Out-Of-Service” by gNB-DU to gNB-CU for the same cell in the GNB DU CONFIGURATION UPDATE messages, and summing up the one or more time intervals of the cell which are determined within the specified time period to calculate the total cell In-Service duration. If there is no Out-Of-Service status reported within the specified time period for a cell, then for such cell Tout should be taken as the point in time when the measurement is being performed. The measurement is split into sub-counters per NCGI. Each measurement is an integer value representing the number of minutes for which the cell was in-Service. The number of measurements is equal to the number of NCGIs (cells).

The average cell availability may be calculated by summing up all measurements for the total cell In-Service duration and then dividing the result by total number of active cells (NR CGIs) present in Cells Status List in GNB-DU CONFIGURATION UPDATE message of all the gNB-DUs in a gNB-CU as explained in TS 38.473 clause 9.2.1.7. It is a time duration value obtained in seconds or minutes or hours. Further, the average network availability is calculated based on the average cell availability and a number of base stations (gNB-CUs) present in the communication network. It is obtained by summing all measurements of average cell availability and then dividing the result by the total number of gNB-CUs present in the network. It is a time duration value obtained in seconds or minutes or hours.

At block 407, the method 400 may include comparing the calculated performance metrics with the respective threshold values to determine whether at least one of the calculated performance metrics exceeds the respective threshold value. At block 409, the method 400 may include transmitting the notification for threshold crossing for the calculated performance metrics to the DSO 103 when at least one of the calculated performance metrics exceeds the respective threshold value. Further, the block 411 recites transmitting the calculated performance metrics to the DSO 103. In an embodiment, the transmitting of the notification for threshold crossing for the calculated performance metrics is performed based on at least one of an explicit subscription or an implicit subscription. The explicit subscription may comprises receiving a subscription control message from the DSO (103), and wherein the subscription control message comprises an address of the DSO (103) to receive at least one of the notification and the performance metrics. Further, transmitting of the calculated performance metrics is based on at least one of an explicit subscription or an implicit subscription. The explicit subscription comprises receiving a subscription control message from the DSO (103), and wherein the subscription control message comprises an address of the DSO (103) to receive the notification and the performance metrics.

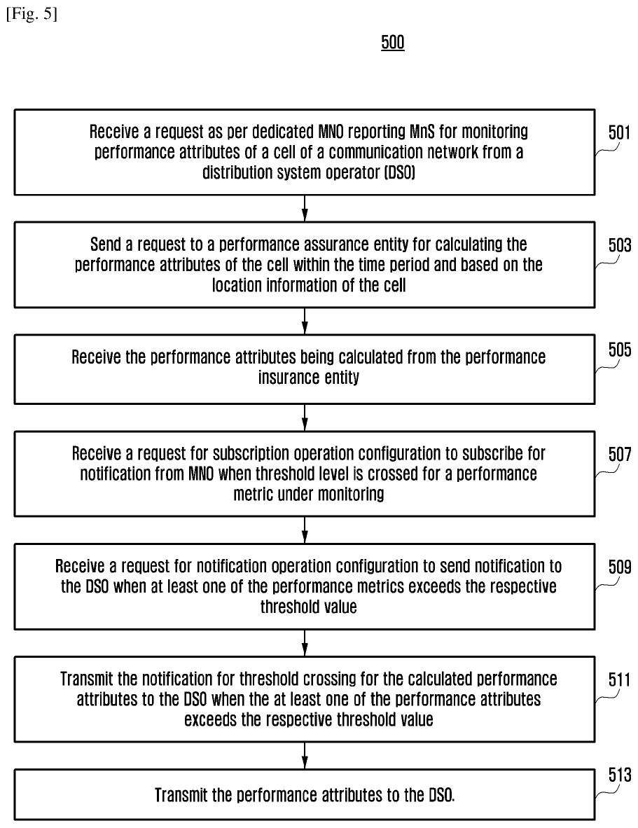

FIG. 5 shows a flowchart illustrating a method for network performance measurement based on dedicated service approach, in accordance with some embodiments of the present disclosure.

As illustrated in FIG. 5, the method 500 includes one or more blocks illustrating a method of network performance measurement. The method 500 may be described in the general context of computer executable instructions. Generally, computer executable instructions can include routines, programs, objects, components, data structures, procedures, modules, and functions, which perform functions or implement abstract data types.

The order in which the method 500 is described is not intended to be construed as a limitation, and any number of the described method blocks can be combined in any order to implement the method 500. Additionally, individual blocks may be deleted from the methods without departing from the spirit and scope of the subject matter described herein. Furthermore, the method 500 can be implemented in any suitable hardware, software, firmware, or combination thereof.

At block 501, the method 500 may include receiving a request as per dedicated MNO reporting MnS for monitoring performance metrics of a cell of a communication network from a distribution system operator (DSO) 103. The request comprises a threshold info for each of the performance metrics, an identifier and/or location information of the cell, and a time period of monitoring.

At block 503, the method 500 may include sending a request to a performance assurance entity for calculating the performance metrics of the cell within the time period and based on the identifier and/or location information of the cell. At block 505, the method may comprise receiving the performance metrics being calculated from the performance assurance entity. The performance metrics comprise one or more cell performance measurements and one or more cell KPIs. The one or more cell performance measurements are selected from a group of: Total cell outage duration, Average cell outage duration and Total cell In-Service duration. The one or more cell KPIs are selected from a group of: an average cell availability and an average network availability.

The total cell outage duration indicates a total time duration when the cell in the communication network is out of service. The total cell outage duration may be calculated by: determining one or more time intervals between time stamps Tₒᵤₜ and Tᵢₙ, wherein Tout is the time stamp when Service Status is reported as “Out-Of-Service” by gNB-DU to gNB-CU for a cell and Tin is the time stamp when the Service Status is reported as “In-Service” for the same cell by gNB-DU to gNB-CU in the GNB DU CONFIGURATION UPDATE messages; and summing up the one or more time intervals of the cell which are determined within the specified time period to calculate the total cell outage duration. If there is no In-Service status reported within the specified time period for a cell, then for such cell Tᵢₙ should be taken as the point in time when the measurement is being performed. The measurement is split into sub-counters per NCGI. Each measurement is an integer value representing the number of seconds or minutes or hours for which the cell was Out-Of-Service. The number of measurements is equal to the number of NCGIs (cells). Further, the average cell outage duration indicates an average time duration of an outage when the cell in the communication network is out of service, wherein the average cell outage duration is calculated by dividing the total cell outage duration with a number of occurrences of the outage for the cell within the specified time period. The measurement is split into sub-counters per NCGI. Each measurement is an integer value representing the average number of seconds or minutes or hours for which the cell was Out-Of-Service per outage occurrence. The number of measurements is equal to the number of NCGIs (cells).

Furthermore, the total cell In-Service duration indicates a total time duration when the cell in the communication network is in-service. The total cell in-service duration is calculated by: determining one or more time intervals between time stamps Tᵢₙ and Tₒᵤₜ, wherein Tin is the time stamp when the Service Status is reported as “In-Service” for a cell by gNB-DU to gNB-CU and Tout is the time stamp when Service Status is reported as “Out-Of-Service” by gNB-DU to gNB-CU for the same cell in the GNB DU CONFIGURATION UPDATE messages, and summing up the one or more time intervals of the cell which are determined within the specified time period to calculate the total cell In-Service duration. If there is no Out-Of-Service status reported within the specified time period for a cell, then for such cell Tout should be taken as the point in time when the measurement is being performed. The measurement is split into sub-counters per NCGI. Each measurement is an integer value representing the number of minutes for which the cell was in-Service. The number of measurements is equal to the number of NCGIs (cells).

The average cell availability may be calculated by summing up all measurements for the total cell In-Service duration and then dividing the result by total number of active cells (NR CGIs) present in Cells Status List in GNB-DU CONFIGURATION UPDATE message of all the gNB-DUs in a gNB-CU as explained in TS 38.473 clause 9.2.1.7. It is a time duration value obtained in seconds or minutes or hours. Further, the average network availability is calculated based on the average cell availability and a number of base stations (gNB-CUs) present in the communication network. It is obtained by summing all measurements of average cell availability and then dividing the result by the total number of gNB-CUs present in the network. It is a time duration value obtained in seconds or minutes or hours.

At block 507, the method 500 may include receiving a request for subscription operation configuration to subscribe for notification from MNO when threshold level is crossed for a performance metric under monitoring. At block 509, the method 500 may include receiving a request for notification operation configuration to send notification to the DSO when at least one of the performance metrics exceeds the respective threshold value. At block 511, the method 500 may include transmitting the notification for threshold crossing for the calculated performance metrics to the DSO 103 when at least one of the calculated performance metrics exceeds the respective threshold value. At block 513, the method recites transmitting the calculated performance metrics to the DSO 103. In an embodiment, the transmitting of the notification for threshold crossing for the calculated performance metrics is performed based on subscription. The explicit subscription may comprise receiving a subscription control message from the DSO (103), and wherein the subscription control message comprises an address of the DSO (103) to receive at least one of the notification and the performance metrics. Further, transmitting of the calculated performance metrics is based on at least one of an explicit subscription or an implicit subscription. The explicit subscription comprises receiving a subscription control message from the DSO (103), and wherein the subscription control message comprises an address of the DSO (103) to receive the notification and the performance metrics.

Furthermore, one or more computer-readable storage media may be utilized in implementing embodiments consistent with the present invention. A computer-readable storage medium refers to any type of physical memory on which information or data readable by a processor 105 may be stored. Thus, a computer-readable storage medium may store instructions for execution by one or more processor 105, including instructions for causing the processor 105 to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### Advantages

The present disclosure discloses network performance measurement by which the present disclosure identifies cell or network availability degradation or failure, cell outage indicated by newly invented measurements and KPIs, can be correlated with network performance events. Network performance can be compared to historic information indicating failures. This may help DSO to take timely reactive or even proactive actions to maintain its smart energy services. Further, one or more measurements and KPIs information will enhance the MNO system 101 service and network visibility for specific user groups (e.g., DSO) that may benefit from this, while making sure that some of them do not develop alternative solutions they can fully control. The present disclosure also provides that ability for the consumer or the user to configure threshold with the performance measurement defined as part of this invention for a particular location of the target node. Further, the ability to check if the current measurement has crossed the configured threshold based on which identifying cell or network availability degradation or failure.

### REFERRAL NUMERALS

| Reference Number | Description |
|---|---|
| 100 | Environment |
| 101 | Mobile Network Operator (MNO) |
| 103 | Distributed system operator |
| 105 | Processor |
| 107 | Transceiver |
| 109 | Memory |
| 203 | Data |
| 205 | Request data |
| 207 | Performance calculation data |
| 209 | Notification data |
| 211 | Other data |
| 213 | Units |
| 215 | Receiving unit |
| 217 | Performance calculation unit |
| 219 | Notification Unit |
| 221 | Other Units |
| 400, 500 | Method |

1. A method performed by a mobile network operator (MNO) in a wireless communication system for network performance measurement, the method comprising:
receiving, from a distribution system operator (DSO), a request for measuring performance metrics of a cell of a network;
generating an information object class (IOC) response for the request; and
transmitting, to the DSO, the (IOC) response.

2. The method of claim 1,
wherein the request comprises a threshold value for each of the performance metrics, a cell availability and a network availability, and location information of the cell (Lat/long, TAC, cellid) used to scope the object instance to be monitored.

3. The method of claim 1, further comprises transmitting, to the DSO, a notification for threshold crossing for calculated performance metrics, in case that the calculated performance metrics exceed respective threshold values.

4. The method of claim 1,
wherein the network performance measurement is based on a network resource model (NRM) configuration.

5. The method of claim 1,
wherein the performance metrics comprise one or more cell performance measurements and one or more key performance identifiers (KPIs).

6. The method of claim 1, further comprises transmitting, to the DSO, a notification for threshold crossing for calculated performance metrics.

7. The method of claim 1, further comprising:
receiving, from the DSO, a request to create an managed object instance (MOI) for ntfsubscriptioncontrol IOC to subscribe for notify threshold crossing notification.

8. A method performed by a distribution system operator (DSO) in a wireless communication system for network performance measurement, the method comprising:
transmitting, to a mobile network operator (MNO), a request for measuring performance metrics of a cell of a network; and
receiving, form the MNO, an information object class (IOC) response.

9. The method of claim 8,
wherein the request comprises a threshold value for each of the performance metrics, a cell availability and a network availability, and location information of the cell (Lat/long, TAC, cellid) used to scope the object instance to be monitored, and
wherein the network performance measurement is based on an NRM configuration.

10. The method of claim 8, further comprises receiving, from the MNO, a notification for threshold crossing for calculated performance metrics, in case that the calculated performance metrics exceed respective threshold values.

11. The method of claim 8,
wherein the performance metrics comprise one or more cell performance measurements and one or more key performance identifiers (KPIs).

12. The method of claim 8, further comprising:
receiving, from the MNO, a notification for threshold crossing for calculated performance metrics.

13. The method of claim 8, further comprises transmitting, to the MNO, a request to create an managed object instance (MOI) for ntfsubscriptioncontrol IOC to subscribe for notify threshold crossing notification.

14. A mobile network operator (MNO) in a wireless communication system for network performance measurement, the MNO comprising:
a transceiver configured to transmit and receive a signal; and
a processor coupled to the transceiver, wherein the processor is configured to:
receive, from a distribution system operator (DSO), a request for measuring performance metrics of a cell of a network,
generate an information object class (IOC) response for the request, and transmit, to the DSO, the (IOC) response.

15. A distribution system operator (DSO) in a wireless communication system for network performance measurement, the DSO comprising:
a transceiver configured to transmit and receive a signal; and
a processor coupled to the transceiver, wherein the processor is configured to:
transmit, to a mobile network operator (MNO), a request for measuring performance metrics of a cell of a network, and
receive, form the MNO, an information object class (IOC) response.
